(19) United States
(12) Patent Application Publication
(10) Pub. No.: US 2007/0022400 A1
(43) Pub. Date: Jan. 25, 2007

(54) Method, program, and apparatus for designing layout of semiconductor integrated circuit

(75) Inventor: Tadafumi Kadota, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/436,520

(22) Filed: May 19, 2006

(30) Foreign Application Priority Data
Jul. 19, 2005 (JP) 2005-208531

(51) Int. Cl. G06F 17/50

(52) U.S. Cl. 716/13; 716/10

(57) ABSTRACT

In a method for designing a layout for an LSI, library data, which is information on a standard cell with an assigned parameter or parameters each indicating the probability of occurrence of violations of design rules at a pin connection point, is read into a library information read section in a global routing processing device. And in a global routing density processing section and a wire route determination processing section, the density of global routes that pass above a chip area divided into a plurality of portions in a grid pattern by a grid division processing section is set according to the parameters, so that the density of routes at pin connection points where the probability of occurrence of violations of design rules is high becomes low. Therefore, the global routing is carried out in such a manner that occurrence of violations of design rules at the pin connection points are prevented as much as possible.

### CROSS-REFERENCE TO RELATED APPLICATION

This Non-provisional application claims priority under 35 U.S.C. § 119(a) on Patent Application No. 2005-208531 filed in Japan on Jul. 19, 2005, the entire contents of which are hereby incorporated by reference.

### BACKGROUND OF THE INVENTION

The present invention relates to an automatic layout method, program, and apparatus for determining global routes with consideration given to wire closure, when a semiconductor integrated circuit is designed.

In recent years, as microscaling of semiconductor fabrication processes has progressed, the influence of wiring delay time is no longer negligible in designing a semiconductor integrated circuit. Signal delay time is broadly divided into cell delay time and wiring delay time. Previously, the cell delay time was predominant and it was thus easy to estimate signal delay in a semiconductor integrated circuit in a step for designing logic circuits. However, since capacitance between wires has been increasing due to the microscaling of the fabrication processes, the wiring delay time has become dominant. Therefore, to estimate signal delay in a semiconductor integrated circuit, wiring delay time based on the distance between cells must be considered when a layout for the semiconductor integrated circuit is designed. Consequently, a method in which wire capacitance and wire resistance are calculated using virtual wire routes called global routes and then the wire capacitance and the wire resistance are taken into account in estimating wiring delay time is becoming mainstream. In the global routing, cell-to-cell connection routes are estimated using, e.g., a structure called a Steiner tree. And finally, the actual routing called detailed routing is performed based on the global routes, which allows the completion of the layout in which the wire capacitance and the wire resistance do not differ greatly from the estimations. This layout method is described, e.g., in pp. 51-58 in “EDA in the age of system-on-chips, Integration of logic synthesis and automatic layout” by Ikutaro Kojima, the Aug. 23rd 1999 issue of Nikkei Electronics (Nikkei Business Publications Inc.)

Generally, timing closure and wire closure are critical in layout design. To achieve timing closure, timing design based on global routes has to be made in an early step in the layout design. To achieve wire closure, it is important to establish the global routes so that the actual routing can be performed in a later step. Conventionally, it has been possible to eventually complete routing without violations of design rules by giving sufficient consideration to global routing.

Nevertheless, as the size of standard cells has been decreased, the number of violations of design rules occurring at connection points between wires and pins of the standard cells has been increasing. In a global routing process step, it is not possible to estimate violations of design rules occurring due to pins and wires connected to those pins, and the portions of the layout in which design rule violations have occurred are often needed to be corrected manually after the detailed routing, resulting in a manifestation of the problem of increase in the number of process steps.

### SUMMARY OF THE INVENTION

In view of the above problem, it is therefore an object of the present invention to carry out global routing in such a manner that occurrence of violations of design rules at pin connection points are prevented as much as possible

In order to achieve the above object, according to the present invention, the probability of occurrence of violations of design rules at each pin connection point is represented by a parameter in which an index based on a characteristic of the pin is used, and this parameter is assigned to information on the standard cell having that pin so that the parameter is taken into account when global routing is carried out. This allows, in the global routing step, route design to be carried out considering violations of design rules at each pin connection point. Specifically, the density of the global routes at those pin connection points where the probability of occurrence of violations of design rules is high is set low.

More specifically, an inventive method for automatically laying out a semiconductor integrated circuit includes: the parameter assignment step of assigning, for each of standard cells in the semiconductor integrated circuit, one or more parameters to an information set on that standard cell, each parameter indicating the probability of occurrence of violations of design rules at a connection point between a corresponding pin and a wire in that standard cell; and the global routing processing step of carrying out global routing for the semiconductor integrated circuit in such a manner that with consideration given to the assigned one or more parameters, as the probability of occurrence of violations of the design rules is increased, density of wire routes at the wire connection point is lowered.

In one embodiment of the inventive method, in the parameter assignment step, the number of parameters assigned to each of the standard cell information sets is one.

In another embodiment, in the parameter assignment step, the number of parameters assigned to each of the standard cell information sets is two or more.

In another embodiment, in the parameter assignment step, the one or more parameters are weighted and the weighed one or more parameters are assigned to each of the standard cell information sets; and in the global routing processing step, according to the weighted one or more parameters assigned in the parameter assignment step, the wire route density is set, thereby performing the global routing for the semiconductor integrated circuit.

In another embodiment, the global routing processing step includes: the grid division sub-step of dividing, in a grid pattern, a chip area in which the semiconductor integrated circuit is to be formed, and the global routing density adjustment sub-step of determining the degree of lowering of the wire route density for each of unit grid spaces created by the division performed in the grid division sub-step, with consideration given to a positional relation between the unit grid space and a corresponding one or more of the standard cells.

In another embodiment, in the global routing density adjustment sub-step, the degree of lowering of the wire route density is determined in accordance with an area occupied by the corresponding one or more standard cells existing in the unit grid space.

In another embodiment, in the global routing density adjustment sub-step, if a single standard cell extends into two or more of the unit grid spaces, a parameter corresponding to an area occupied by the single standard cell in each of the two or more unit grid spaces is assigned to each of the two or more unit grid spaces and the degree of lowering of the wire route density is determined based on these parameters.

In another embodiment, the global routing processing step further includes the wire route determination sub-step of determining the wire routes of the global routing, wherein in cost calculation for determining the wire routes, the degree of lowering of the wire route density determined for each of two or more of the unit grid spaces existing under candidate routes is taken into account.

In another embodiment, in the parameter assignment step, each parameter is calculated in accordance with the shape of the corresponding pin in the corresponding standard cell and assigned to the information set on that corresponding standard cell.

In another embodiment, in the parameter assignment step, each parameter is calculated in accordance with the number of pins in the corresponding standard cell and assigned to the information set on that corresponding standard cell.

In another embodiment, in the parameter assignment step, each parameter is calculated in accordance with density of pins in the corresponding standard cell and assigned to the information set on that corresponding standard cell.

In another embodiment, in the parameter assignment step, each parameter is calculated in accordance with the number of layers used by the corresponding pin in the corresponding standard cell and assigned to the information set on that corresponding standard cell.

In another embodiment, in the parameter assignment step, each of the parameters, calculated respectively in accordance with the shape of the corresponding pin, the number of pins, density of the pins, and the number of layers used by the corresponding pin in the corresponding standard cell, is weighted, the weighted parameters are added together to obtained a single total parameter, and the obtained parameter is assigned to the information set on that corresponding standard cell.

An inventive program for automatically laying out a semiconductor integrated circuit is used to make a computer execute processing including: the parameter assignment step of assigning, for each of standard cells in the semiconductor integrated circuit, one or two or more parameters to an information set on that standard cell, each parameter indicating the probability of occurrence of violations of design rules at a connection point between a corresponding pin and a wire in that standard cell; and the global routing processing step of carrying out global routing for the semiconductor integrated circuit in such a manner that density of wire routes at each of wire connection points where the probability of occurrence of violations of the design rules is high is lowered in accordance with the assigned one or two or more parameters.

In one embodiment of the inventive program, in the parameter assignment step, the computer is made to execute processing in which the one parameter is assigned to each of the standard cell information sets.

In another embodiment, in the parameter assignment step, the computer is made to execute processing in which the two or more parameters are assigned to each of the standard cell information sets.

In another embodiment, the computer is made to execute processing in which in the parameter assignment step, a weight is assigned to each of the one or two or more parameters; and in the global routing processing step, according to the weighted one or two or more parameters assigned in the parameter assignment step, the degree of lowering of the wire route density in the global routing is adjusted, thereby freely adjusting effect of the one or two or more parameters.

In another embodiment, in the global routing processing step, the computer is made to execute processing including: the grid division sub-step of dividing, in a grid pattern, a chip area in which the semiconductor integrated circuit is to be formed, and the global routing density adjustment sub-step of determining the degree of lowering of the wire route density in the global routing for each of unit grid spaces created by the division performed in the grid division sub-step, with consideration given to a positional relation between the unit grid space and a corresponding one or more of the standard cells.

In another embodiment, in the global routing density adjustment sub-step, the computer is made to execute processing in which the degree of lowering of the wire route density in the global routing is calculated in accordance with an area occupied by the corresponding one or more standard cells existing in the unit grid space.

In another embodiment, in the global routing density adjustment sub-step, the computer is made to execute processing in which if a single standard cell extends into two or more of the unit grid spaces, a parameter based on an area occupied by the single standard cell in each of the two or more unit grid spaces is assigned to each of the two or more unit grid spaces and the degree of lowering of the wire route density in the global routing is calculated based on these parameters.

In another embodiment, in the global routing processing step, the computer is made to execute processing in which the wire routes of the global routing are determined, with consideration given to two or more of the unit grid spaces existing under candidate routes when cost calculation for determining the wire routes is performed.

In another embodiment, in the parameter assignment step, the computer is made to execute processing in which the one or two or more parameters, each calculated in accordance with the shape of the corresponding pin in the corresponding standard cell, are assigned.

In another embodiment, in the parameter assignment step, the computer is made to execute processing in which the one or two or more parameters, each calculated in accordance with the number of pins in the corresponding standard cell, are assigned.

In another embodiment, in the parameter assignment step, the computer is made to execute processing in which the one or two or more parameters, each calculated in accordance with density of pins in the corresponding standard cell, are assigned.

In another embodiment, in the parameter assignment step, the computer is made to execute processing in which the one or two or more parameters, each calculated in accordance with the number of layers used by the corresponding pin in the corresponding standard cell, are assigned.

In another embodiment, in the parameter assignment step, the computer is made to execute processing in which each of the parameters, calculated respectively in accordance with the shape of the corresponding pin, the number of pins, density of the pins, and the number of layers used by the corresponding pin in the corresponding standard cell, is weighted, the weighted parameters are added together to obtained a single total parameter, and the obtained parameter is assigned to the information set on that corresponding standard cell.

In another embodiment, the program includes the step of making the computer execute processing in which each parameter is written in logical library information.

In another embodiment, the program includes the step of making the computer execute processing in which each parameter is written in a file.

An inventive apparatus for automatically laying out a semiconductor integrated circuit includes: a program storage device for storing therein the above-mentioned automatic layout program; a data storage device for storing therein layout data; and an arithmetic processing unit for performing execution processing by using the program stored in the program storage device and the layout data stored in the data storage device.

In one embodiment of the inventive apparatus, in the program storage device, the above-mentioned automatic layout programs are all stored.

As described above, according to the present invention, layout information sets on respective standard cells in a semiconductor integrated circuit are each assigned one or more parameters, each of which indicates the probability of occurrence of violations of design rules at a connection point between a corresponding pin and a wire in the standard cells. And according to the assigned parameters, global routing is designed in such a manner that as the probability of occurrence of violations of design rules at the wire connection point is increased, the route density at the wire connection point is reduced. It is thus possible to suppress occurrence of violations of the design rules around the pins in the standard cells, which would otherwise particularly cause problems in the global routing step. As a result, it is possible to significantly suppress violations of the design rules occurring in the global routing step.

### BRIEF DESCRIPTION OF THE DRAWINGS

FIG. 1 is a flow chart showing part of an automatic layout method according to an embodiment of the present invention, in which library processing is performed.

FIG. 2 is a flow chart showing part of the automatic layout method according to the embodiment of the present invention, in which routing processing is performed.

FIG. 3 shows the configuration of a standard cell according to the embodiment of the present invention.

FIG. 4 shows a chip area divided in a grid pattern according to the embodiment of the present invention.

### DETAILED DESCRIPTION OF THE INVENTION

Hereinafter, preferred embodiments of the present invention will be described in detail with reference to the accompanying drawings.

First of all, the entire process flow will be described.

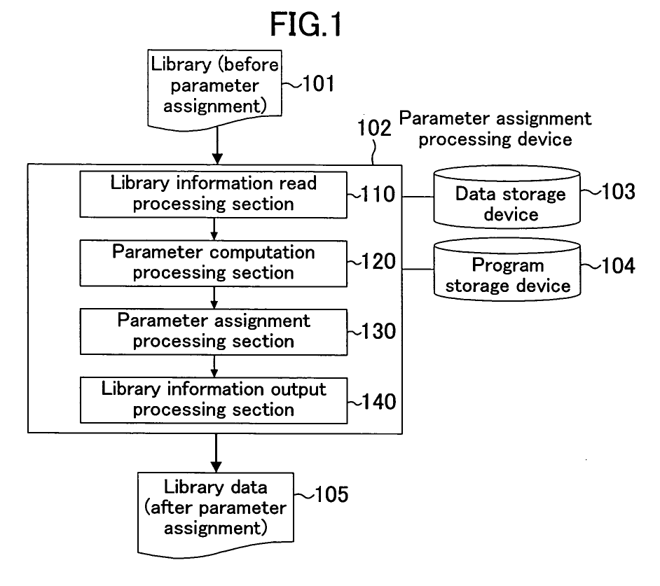

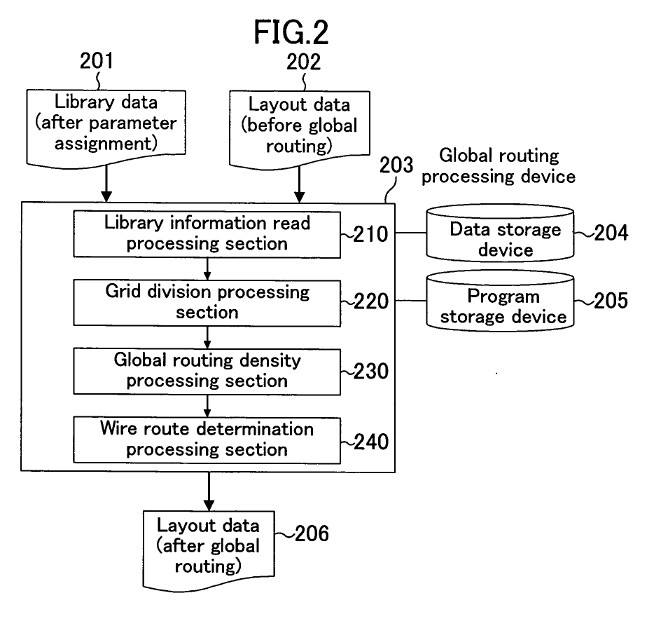

The entire process flow is broadly divided into two processes: a process for assigning parameters to information about standard cells and a process for carrying out global routing. A configuration for performing these processes is shown in FIGS. 1 and 2. FIG. 1 shows part of the configuration for performing the parameter assigning process, while FIG. 2 shows part of the configuration for carrying out the global routing process.

In FIG. 1, the reference numeral 101 denotes library in which information sets on standard cells before parameter assignment are stored. The reference numeral 102 refers to a parameter assignment processing device for receiving an information set on a standard cell stored in the library 101 and performing the parameter assignment process for that information set. The parameter assignment processing device 102 outputs library data 105, which is an information set on the standard cell to which one or more parameters have been assigned. The information set in the library 101 and the detailed processing results obtained in the parameter assignment processing device 102 during the process are stored in a data storage device 103. The process program is stored in a program storage device 104. Details of the parameter assignment processing device 102 will be discussed later.

On the other hand, FIG. 2 shows the global routing process. The reference numeral 201 denotes library data, which is an information set on a standard cell with one or more parameters assigned by the parameter assignment processing device 102. The library data 201 is thus the same as the library data 105 shown in FIG. 1. The reference numeral 202 refers to layout data before global routing. The reference numeral 203 indicates a global routing processing device for receiving the library data 201 and the layout data 202, carrying out a global routing process, and outputting layout data 206 after the global routing. The library data 201 and the detailed processing results obtained in the global routing processing device 203 during the process are stored in a data storage device 204. The process program is stored in a program storage device 205. The global routing processing device 203 will be discussed in detail later.

The above-described processes performed by the parameter assignment processing device 102 and the global routing processing device 203 are executed by an arithmetic processing unit in the computer.

Next, the parameter assignment processing device 102 will be described in detail.

As shown in FIG. 1, the parameter assignment processing device 102 includes a library information read processing section 110, a parameter computation processing section 120, a parameter assignment processing section 130, and a library information output processing section 140.

First, an information set on a standard cell in the library 101 is read into the library information read processing section 110 in the parameter assignment processing device 102 (in a library information read step).

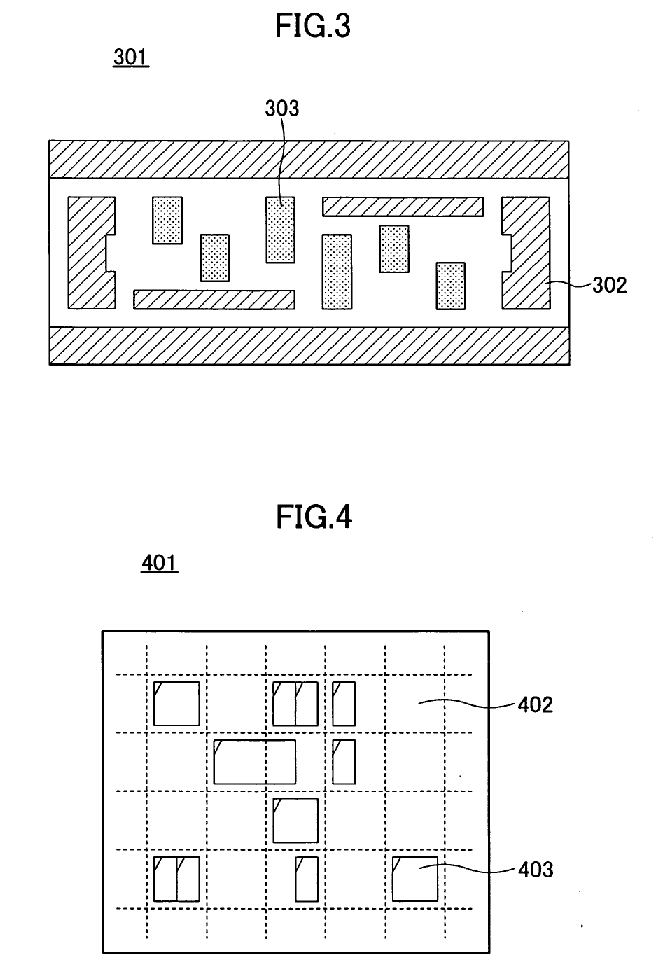

Next, information on the shape of the standard cell, which is obtained from the information set in the library 101 read into the library information read processing section 110, is read into the parameter computation processing section 120. In accordance with this information, one or more parameters are calculated, each of which indicates the probability of occurrence of violations of design rules at a pin connection point. Specifically, in FIG. 3, a standard cell 301 is shown and the reference numeral 302 denotes a pin for a layer and the reference numeral 303 refers to a pin for another layer. In the parameter computation processing section 120, some indexes are extracted from information about the pins 302 and 303 of the standard cell 301, and a parameter is calculated for each pin according to a corresponding one or more of the extracted indexes (in a parameter computation processing step). Specific examples of the indexes will be shown in the following (1-1) to (1-6).

(1-1) In a case where a parameter is calculated with the shape of a pin used as an index.

When the shape of a pin is not rectangular and has a complicated shape, violations of design rules are more likely to occur at the time of pin connection. The complexity of the pin's shape can be quantitatively indicated by using the number of the sides of the pin as a parameter. It can be therefore said that the larger the total number of the sides of the pin is, the more complicated the shape of the pin becomes. This index is effective for standard cells in which the probability of occurrence of violations of design rules depends upon the shapes of pins in those standard cells.

(1-2) In a case where a parameter is calculated with the number of pins used as an index.

As the number of pins included in a single standard cell is increased, violations of design rules are more likely to occur at the time of pin connection. This index is effective for standard cells in which the probability of occurrence of violations of design rules depends upon the number of pins in those standard cells.

(1-3) In a case where a parameter is calculated with the density of pins used as an index.

As the pins in a single standard cell occupy more space in the area of that single standard cell, violations of design rules are more likely to occur at the time of pin connection. This index is effective for standard cells in which the probability of occurrence of violations of design rules depends upon the density of pins in those standard cells.

(1-4) In a case where a parameter is calculated with the number of layers used by a pin used as an index.

When a pin in a single standard cell uses a plurality of layers, violations of design rules are more likely to occur at the time of pin connection. This index is effective for standard cells in which the probability of occurrence of violations of design rules depends upon the number of layers used by the pins in those standard cells.

(1-5) In a case where a parameter is calculated with a combination of the indexes of the above-mentioned cases (1-1) to (1-4) used as an index.

The indexes of the respective cases are weighted and the weighted indexes are combined into a single index. This index is effective for standard cells in which the probability of occurrence of violations of design rules depends compositely upon the factors described in the above cases (1-1) to (1-4).

(1-6) In a case where a single standard cell is assigned the parameters of the above-mentioned cases (1-1) to (1-4).

For example, for the pin density, if a parameter is calculated for each layer, the probability of occurrence of violations of design rules can be indicated for each layer, whereby routing resources can be used more effectively when global routing is performed.

As to the above indexes, in a case where a standard cell has wires that are connected with outside wires without using pins, if these wires are also considered as pins, it is possible to carry out global routing in accordance with the same algorithm based on the probability of occurrence of violations of design rules at the pin connection points.

The parameter or parameters obtained in the above manners are assigned to the information set on the standard cell (in a parameter assignment processing step) and the information set is stored in a database.

The standard information set, assigned the one or more parameters and stored in the database, is read from the database by the library information output processing section 140 (in a library information read processing step) and then output as the post-parameter-assignment library data 105.

Next, the global routing processing device 203 will be described in detail.

As shown in FIG. 2, the global routing processing device 203 includes a library information read processing section 210, a grid division processing section 220, a global routing density processing section 230, and a wire route determination processing section 240.

First, the library data 201 (i.e., the library data 105 shown in FIG. 1), which is an information set on a standard cell with an assigned parameter or parameters, is read and stored in a database (in a library information read processing step).

Next, the layout data 202 before global routing is read and a chip area shown by the layout data 202 is divided into regions in a grid pattern (in a grid division processing step). Now, the division of the chip area will be described with reference to FIG. 4. In FIG. 4, the reference numeral 401 indicates the entire chip area. Each of the regions 402 obtained by the division of the chip area 401 as indicated by dashed lines is called a unit grid space. The reference numeral 403 refers to each standard cell. FIG. 4 shows an example in which for convenience of description, the shape of each unit grid space 402 is rectangular and the length of each side of the rectangle is the same as the height of the standard cell 403. It should be noted that the shape of the unit grid spaces 402 and the length of the sides thereof are not limited to this example, but may be set to various other shapes and lengths.

After the grid division of the chip area 401 as shown in FIG. 4, the global routing density processing section 230 obtains a value for controlling the global routing density for each unit grid space 402 in accordance with the parameter or parameters of the one or more standard cells 403 existing in that unit grid space 402 (in a global routing density processing step). Exemplary calculations for obtaining the value for controlling the global routing density will be described in the following (2-1) and (2-2).

(2-1) In a case where one or more standard cells are placed within a single unit grid space.

A parameter of each standard cell is multiplied by the proportion of the area occupied by that standard cell in the unit grid space, and the obtained values are successively added together. For example, suppose a case in which two standard cells are present within a unit grid space and for one of the standard cells, the parameter is P1 and the proportion of the area occupied by the one standard cell in the unit grid space is A1% and for the other standard cell, the parameter is P2 and the proportion of the area occupied by the other standard cell in the unit grid space is A2%. In this case, the value for controlling the global routing density for this unit grid space is expressed as P1×A1/100+P2×A2/100(≦1).

(2-2) In a case where a single standard cell extends into a plurality of unit grid spaces.

The area occupied by the standard cell in each unit grid space is multiplied by a parameter of the standard cell, and the obtained value is allocated to the unit grid space. For instance, assume a case in which a single standard cell with a parameter P extends into two unit grid spaces and the proportion of the area occupied by this standard cell in one of the unit grid spaces is B1%, and in the other unit grid space, B2%. In this case, the values for controlling the global routing density for the respective unit grid spaces are expressed as P×B1/100(≦1) and P×B2/100(≦1).

When the value for controlling the global routing density is calculated for each of the unit grid spaces, the calculations are made in the above-mentioned manners.

Then, for each unit grid space, the number of global routes that can pass above that unit grid 'space is calculated. For example, suppose a case in which C global routes can pass above a unit grid space if not obstructed by other routes. In this case, if the value for controlling the global routing density for this unit grid space is X (for example, X=P1×A1/100+P2×A2/100), C×X (≦C) global routes can pass above this unit grid space.

Also, it is possible to change the value for controlling the global routing density by assigning a weight. For example, in the case in which if not obstructed, C global routes can pass above a unit grid space, when the value for controlling the global routing density for this unit grid space is X and the weight assigned to the value X is w, C×wX (≦C) global routes can pass. This weight assignment allows for control in which the probability of occurrence of violations of design rules at pin connection points is taken into account more strictly or more optimistically.

With respect to the foregoing descriptions, when there is a single standard cell in a unit grid space and the single standard cell has a single parameter, there is one value for controlling the global routing density for that unit grid space. On the other hand, when the single standard cell has a plurality of parameters, there are a plurality of values for controlling the global routing density for the unit grid space.

In accordance with the values for controlling the global routing density obtained in the above manners, the wire route determination processing section 240 carries out the global routing (in a wire route determination processing step). The algorithm for carrying out the global routing is based on a structure such as a Steiner tree, as has been conventional. In cost calculations for determining the global routes, if the costs of a plurality of candidate routes for reaching the same destination are the same, the global-routing-density control value or values for the respective unit grid space or spaces 402 that exist under each candidate route are added to the cost of that candidate route. This makes it possible to further lower the probability of occurrence of violations of design rules.

Then, the global routing processing device 203 outputs the post-global-routing layout data 206, and the subsequent process is performed.

As described above, in this embodiment, the allowable number of global routes based on the probability of occurrence of violations of design rules is limited for each unit grid space, and the global routes are determined according to that number, thereby allowing reduction in the global routing density in those standard cells in which the probability of occurrence of violations of design rules is high. Therefore, in a step for correcting portions of the layout in which design rule violations have actually occurred after the detailed routing, no wire congestion occurs, allowing easy correction.

What is claimed is:

1. A method for automatically laying out a semiconductor integrated circuit, comprising:
the parameter assignment step of assigning, for each of standard cells in the semiconductor integrated circuit, one or more parameters to an information set on that standard cell, each parameter indicating the probability of occurrence of violations of design rules at a connection point between a corresponding pin and a wire in that standard cell; and
the global routing processing step of carrying out global routing for the semiconductor integrated circuit in such a manner that with consideration given to the assigned one or more parameters, as the probability of occurrence of violations of the design rules is increased, density of wire routes at the wire connection point is lowered.

2. The method of claim 1, wherein in the parameter assignment step, the number of parameters assigned to each of the standard cell information sets is one.

3. The method of claim 1, wherein in the parameter assignment step, the number of parameters assigned to each of the standard cell information sets is two or more.

4. The method of claim 1, wherein in the parameter assignment step, the one or more parameters are weighted and the weighed one or more parameters are assigned to each of the standard cell information sets; and
in the global routing processing step, according to the weighted one or more parameters assigned in the parameter assignment step, the wire route density is set, thereby performing the global routing for the semiconductor integrated circuit.

5. The method of claim 1, wherein the global routing processing step includes:
the grid division sub-step of dividing, in a grid pattern, a chip area in which the semiconductor integrated circuit is to be formed, and
the global routing density adjustment sub-step of determining the degree of lowering of the wire route density for each of unit grid spaces created by the division performed in the grid division sub-step, with consideration given to a positional relation between the unit grid space and a corresponding one or more of the standard cells.

6. The method of claim 5, wherein in the global routing density adjustment sub-step, the degree of lowering of the wire route density is determined in accordance with an area occupied by the corresponding one or more standard cells existing in the unit grid space.

7. The method of claim 5, wherein in the global routing density adjustment sub-step, if a single standard cell extends into two or more of the unit grid spaces, a parameter corresponding to an area occupied by the single standard cell in each of the two or more unit grid spaces is assigned to each of the two or more unit grid spaces and the degree of lowering of the wire route density is determined based on these parameters.

8. The method of claim 5, wherein the global routing processing step further includes the wire route determination sub-step of determining the wire routes of the global routing, wherein in cost calculation for determining the wire routes, the degree of lowering of the wire route density determined for each of two or more of the unit grid spaces existing under candidate routes is taken into account.

9. The method of claim 1, wherein in the parameter assignment step, each parameter is calculated in accordance with the shape of the corresponding pin in the corresponding standard cell and assigned to the information set on that corresponding standard cell.

10. The method of claim 1, wherein in the parameter assignment step, each parameter is calculated in accordance with the number of pins in the corresponding standard cell and assigned to the information set on that corresponding standard cell.

11. The method of claim 1, wherein in the parameter assignment step, each parameter is calculated in accordance with density of pins in the corresponding standard cell and assigned to the information set on that corresponding standard cell.

12. The method of claim 1, wherein in the parameter assignment step, each parameter is calculated in accordance with the number of layers used by the corresponding pin in the corresponding standard cell and assigned to the information set on that corresponding standard cell.

13. The method of claim 1, wherein in the parameter assignment step, each of the parameters, calculated respectively in accordance with the shape of the corresponding pin, the number of pins, density of the pins, and the number of layers used by the corresponding pin in the corresponding standard cell, is weighted, the weighted parameters are added together to obtained a single total parameter, and the obtained parameter is assigned to the information set on that corresponding standard cell.

14. A program for automatically laying out a semiconductor integrated circuit, wherein the program is used to make a computer execute processing including:
the parameter assignment step of assigning, for each of standard cells in the semiconductor integrated circuit, one or two or more parameters to an information set on that standard cell, each parameter indicating the probability of occurrence of violations of design rules at a connection point between a corresponding pin and a wire in that standard cell; and
the global routing processing step of carrying out global routing for the semiconductor integrated circuit in such a manner that density of wire routes at each of wire connection points where the probability of occurrence of violations of the design rules is high is lowered in accordance with the assigned one or two or more parameters.

15. The program of claim 14, wherein in the parameter assignment step, the computer is made to execute processing in which the one parameter is assigned to each of the standard cell information sets.

16. The program of claim 14, wherein in the parameter assignment step, the computer is made to execute processing in which the two or more parameters are assigned to each of the standard cell information sets.

17. The program of claim 14, wherein the computer is made to execute processing in which
in the parameter assignment step, a weight is assigned to each of the one or two or more parameters; and
in the global routing processing step, according to the weighted one or two or more parameters assigned in the parameter assignment step, the degree of lowering of the wire route density in the global routing is adjusted, thereby freely adjusting effect of the one or two or more parameters.

18. The program of claim 14, wherein in the global routing processing step, the computer is made to execute processing including:
the grid division sub-step of dividing, in a grid pattern, a chip area in which the semiconductor integrated circuit is to be formed, and
the global routing density adjustment sub-step of determining the degree of lowering of the wire route density in the global routing for each of unit grid spaces created by the division performed in the grid division sub-step, with consideration given to a positional relation between the unit grid space and a corresponding one or more of the standard cells.

19. The program of claim 18, wherein in the global routing density adjustment sub-step, the computer is made to execute processing in which the degree of lowering of the wire route density in the global routing is calculated in accordance with an area occupied by the corresponding one or more standard cells existing in the unit grid space.

20. The program of claim 18, wherein in the global routing density adjustment sub-step, the computer is made to execute processing in which if a single standard cell extends into two or more of the unit grid spaces, a parameter based on an area occupied by the single standard cell in each of the two or more unit grid spaces is assigned to each of the two or more unit grid spaces and the degree of lowering of the wire route density in the global routing is calculated based on these parameters.

21. The program of claim 18, wherein in the global routing processing step, the computer is made to execute processing in which the wire routes of the global routing are determined, with consideration given to two or more of the unit grid spaces existing under candidate routes when cost calculation for determining the wire routes is performed.

22. The program of claim 14, wherein in the parameter assignment step, the computer is made to execute processing in which the one or two or more parameters, each calculated in accordance with the shape of the corresponding pin in the corresponding standard cell, are assigned.

23. The program of claim 14, wherein in the parameter assignment step, the computer is made to execute processing in which the one or two or more parameters, each calculated in accordance with the number of pins in the corresponding standard cell, are assigned.

24. The program of claim 14, wherein in the parameter assignment step, the computer is made to execute processing in which the one or two or more parameters, each calculated in accordance with density of pins in the corresponding standard cell, are assigned.

25. The program of claim 14, wherein in the parameter assignment step, the computer is made to execute processing in which the one or two or more parameters, each calculated in accordance with the number of layers used by the corresponding pin in the corresponding standard cell, are assigned.

26. The program of claim 14, wherein in the parameter assignment step, the computer is made to execute processing in which each of the parameters, calculated respectively in accordance with the shape of the corresponding pin, the number of pins, density of the pins, and the number of layers used by the corresponding pin in the corresponding standard cell, is weighted, the weighted parameters are added together to obtained a single total parameter, and the obtained parameter is assigned to the information set on that corresponding standard cell.

27. The program of claim 14, wherein the program includes the step of making the computer execute processing in which each parameter is written in logical library information.

28. The program of claim 14, wherein the program includes the step of making the computer execute processing in which each parameter is written in a file.

29. An apparatus for automatically laying out a semiconductor integrated circuit, comprising:
a program storage device for storing therein the automatic layout program of claim 14;
a data storage device for storing therein layout data; and
an arithmetic processing unit for performing execution processing by using the program stored in the program storage device and the layout data stored in the data storage device.

30. The apparatus of claim 29, wherein in the program storage device, the automatic layout programs of claims 14 to 26 are all stored.
